(19) United States
(12) Patent Application Publication
(10) Pub. No.: US 2016/0249764 A1
(43) Pub. Date: Sep. 1, 2016

(54) AUTOMATIC MACHINE FOR PREPARING BEVERAGES, SUCH AS ESPRESSO COFFEE, CAPPUCCINO AND THE LIKE

(71) Applicants: Cornelis J.M. AARDENBURG, Lugano (CH); SWISS CAFFE ASIA LTD, Hong Kong (CN)

(72) Inventor: Cornelis J. M. AARDENBURG, Lugano (CH)

(73) Assignees: Cornelis J. M. AARDENBURG, Lugano (CH); SWISS CAFFE ASIA LTD, Hong Kong (CN)

(21) Appl. No.: 15/028,767

(22) PCT Filed: Oct. 7, 2014
(86) PCT No.: PCT/EP2014/071403

§ 371 Date: Apr. 12, 2016

(30) Foreign Application Priority Data
Oct. 17, 2013 (IT) MI2013A001726

(51) Int. Cl. A47J 31/44; A47J 31/36; A47J 31/46; A23F 5/14

(52) U.S. Cl. CPC A47J 31/4489; A23F 5/14; A47J 31/36; A47J 31/46

(57) ABSTRACT

An automatic machine for preparing beverages, such as espresso coffee, cappuccino and the like, comprising a water reservoir, a pump, a heating unit, a flow meter interposed between the water reservoir and the pump, and an infusion assembly for accommodating capsules or pods for preparing beverages, and further comprising elements for dispensing hot water in jets, for the emulsion of milk contained in a vessel that is adapted to be arranged below the dispensing opening of the machine.

The present invention relates to an automatic machine for preparing beverages, such as espresso coffee, cappuccino and the like. More specifically, the invention relates to an automatic machine that is capable of preparing espresso coffee by way of capsules or pods, and cappuccino, latte macchiato and the like, also using capsules of coffee.

As is known, automatic machines are increasingly widespread for preparing espresso coffee and cappuccino, which enable the user, for example domestically, to prepare an espresso coffee and/or a cappuccino that are of a quality similar to those served in a bar.

Usually, in order to prepare a cappuccino, steam nozzles are required which can be capable of frothing the milk, and thus emulsify it.

The exit point of the steam nozzle is usually guided manually to the surface of the milk, which has been placed in a container, so that when the steam is released a three-phase region is created that comprises steam/air/milk, thus preparing the emulsified milk.

To this end, steam emission nozzles are made which are simply submerged under the surface of the milk, and by way of a tube, which takes in air above the surface of the milk, the air is drawn into the egress of the steam by the pressure generated by the flowing steam, so that the above-mentioned three-phase region is created under the surface of the milk and the milk is emulsified.

The drawbacks of this solution lie in the fact that there are still parts of the machine that are in direct contact with the milk, and that thus require, at the end of the operation to froth the milk, rinsing and cleaning in order to prevent residues of milk from remaining stuck to the nozzle.

It needs to be remembered that the fat content of the milk is what determines the quality of the emulsion that is created, but it is also what remains stuck to the components of the machine that come into contact with the milk.

The aim of the present invention is to provide a first machine for preparing beverages, particularly espresso coffee, cappuccino and the like, in which the emulsion of the milk occurs without the milk coming into contact of part of the machine.

Within this aim, an object of the present invention is to provide a machine for preparing beverages, such as espresso coffee, cappuccino and the like, which does not require the use of ground coffee.

Another object of the present invention is to provide a machine for preparing beverages, such as espresso coffee, cappuccino and the like, which does not involve the use of steam in order to emulsify the milk for the preparation of the cappuccino.

Another object of the present invention is to provide a machine for preparing beverages that is highly reliable, easily and practically implemented and low-cost.

This aim and this and other objects which will become more evident hereinafter are achieved by an automatic machine for preparing beverages, such as espresso coffee, cappuccino and the like, comprising a water reservoir, a pump, a heating unit, a flow meter interposed between the water reservoir and the pump, and an infusion assembly for accommodating capsules or pods for preparing beverages, characterized in that it comprises means for dispensing hot water in jets, for the emulsion of milk contained in a vessel that is adapted to be arranged below the dispensing opening of said machine.

Further characteristics and advantages of the invention will become more apparent from the description of a preferred, but not exclusive, embodiment of the machine according to the invention, which is illustrated by way of non-limiting example in the accompanying drawings wherein:

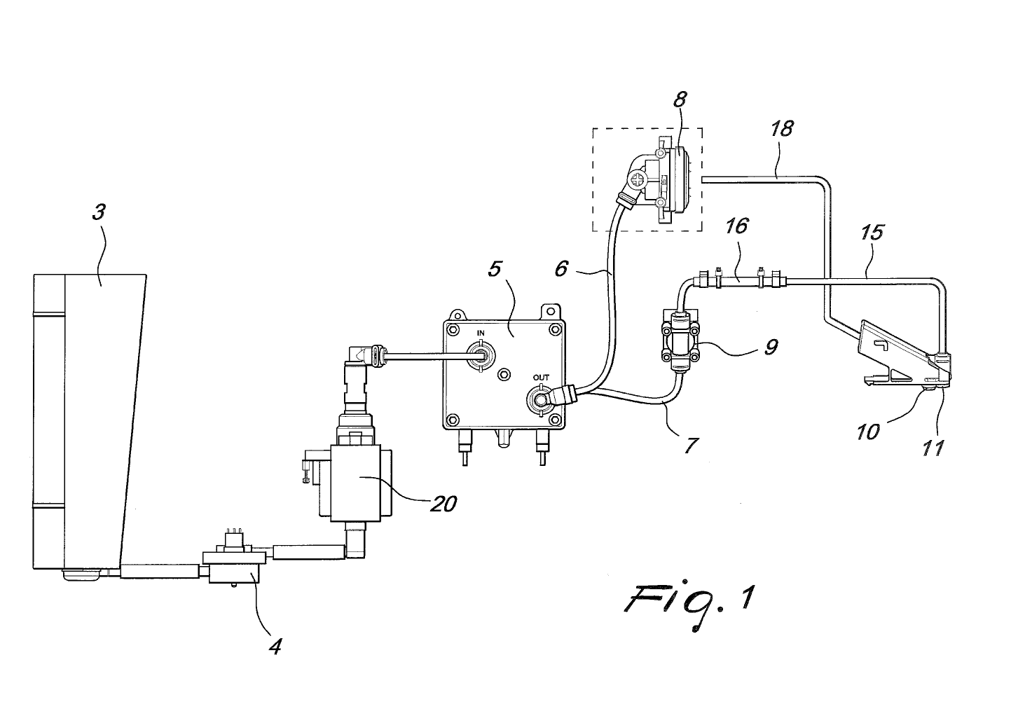

FIG. 1 is a schematic view of the machine for providing beverages according to the present invention;

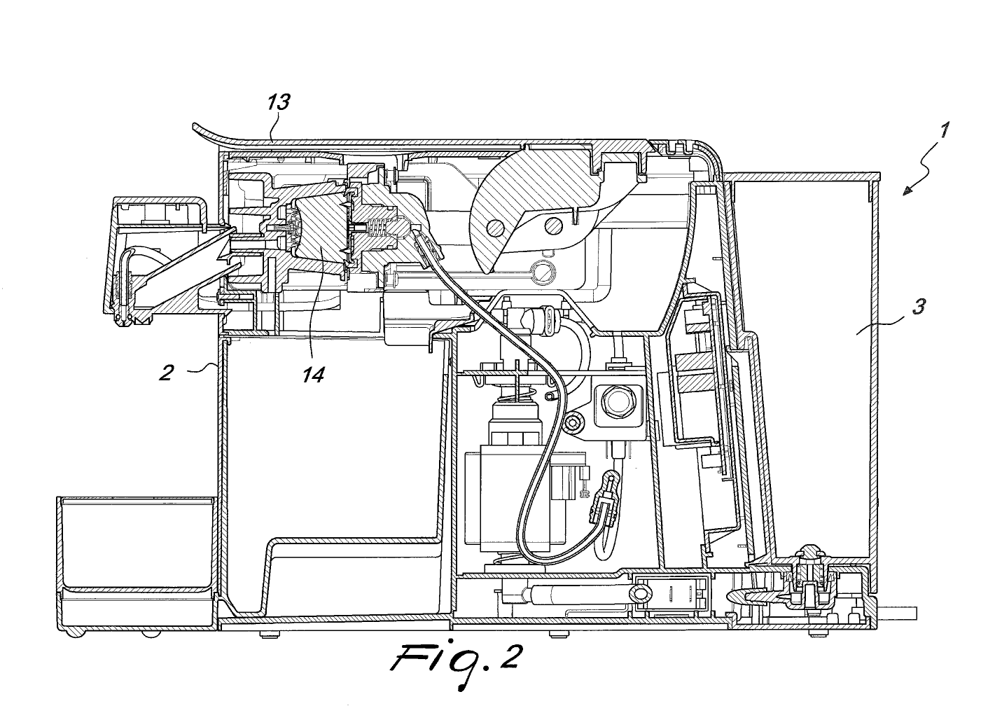

FIG. 2 is a cross-sectional view of the machine according to the invention;

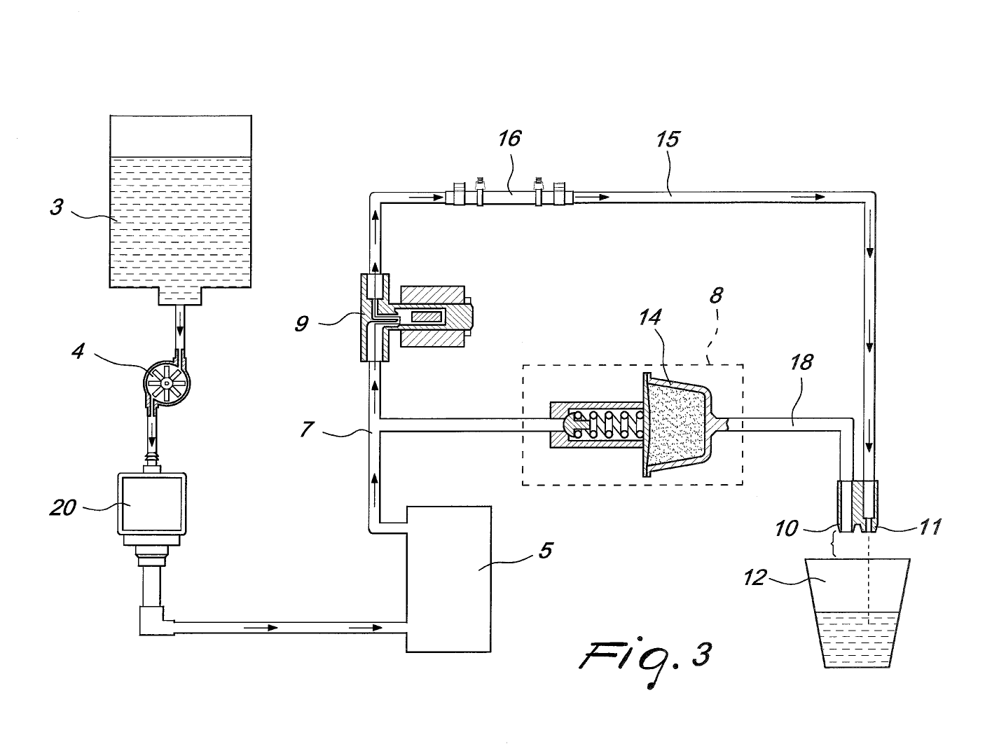

FIG. 3 is a schematic view of a first operating mode of the machine according to the invention;

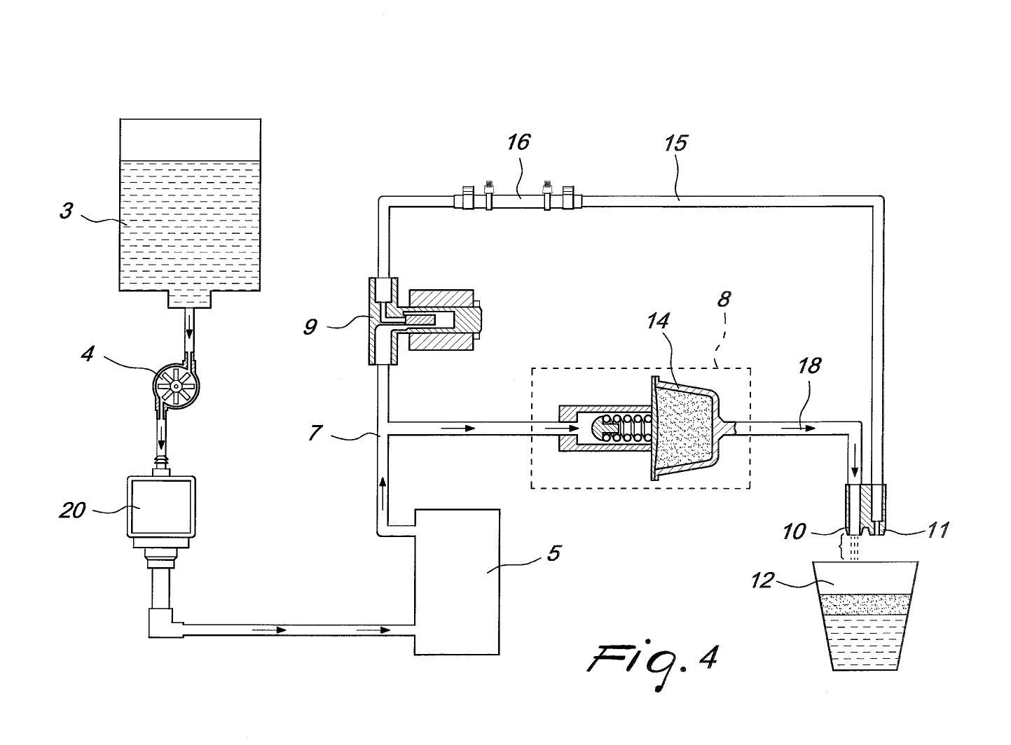

FIG. 4 is a schematic view of a second operating mode of the machine according to the invention.

With reference to the figures, the machine according to the present invention, generally designated with the reference numeral 1, comprises a machine body 2, a water reservoir 3, a flow meter 4 that is connected to the output of the reservoir 3 and also connected to a pump 20 that is adapted to pump water into a heating unit 5 that in turn dispenses the water to two distinct tubes, 6 and 7, the first, 6, leading to an infusion assembly adapted for the use of beverages contained in capsules, such as for example espresso coffee and the like.

The infusion assembly is provided with a device for the perforation of the capsule, of a conventional type. The infusion assembly is generally designated in FIG. 1 by the reference numeral 8.

The infusion assembly 8 is connected to a dispensing opening 10 that enables the emission of a beverage into a vessel 12 below.

The second path that the water heated by the heating unit 5 can take is through a solenoid valve 9 until it reaches an additional dispensing opening 11 that enables the dispensing of hot water in jets.

The infusion assembly 8 is controlled by a lever 13 that, when in the open position, makes it possible to insert a capsule 14 into the machine which contains a preparation for dispensing a beverage.

The machine according to the invention thus makes it possible to add, in a coffee machine that uses capsules, a device for dispensing jets of hot water, which makes it possible to froth the milk, for its emulsion, in order to obtain either frothed milk in the vessel 12, or a cappuccino, by mixing the frothed milk with the coffee dispensed by the infusion assembly 8, or another beverage.

Between the solenoid valve 9 and the additional dispensing opening 11 is a connection tube 15, of which at least one portion 16 is for example made of silicone rubber so as to create a sort of buffer.

With reference to FIGS. 3 and 4, the operation of the machine according to the invention in accordance with two distinct modes of operation is described below. The first mode is shown in FIG. 3, in which the machine is used only for the emulsion of milk which is introduced into the container 12.

The water from the reservoir 3 passes through the flow meter 4, the pump 20, and is conveyed to the heating unit 5 from which it is transferred, if the operator has chosen to froth the milk only, through the tube 7 to the solenoid valve 9 and thus to the tube 15 for dispensing jets of hot water from the additional dispensing opening 11. The dispensing can occur with a pulsed high-pressure jet.

The jet of hot water is optimized by the presence of the buffer constituted by the portion of tube made of silicone rubber 16.

Therefore, without any contact between the machine, or any part thereof, and the milk contained in the vessel 12, the milk can be frothed in a highly efficient manner, without the necessity of generation of steam, thus also saving energy.

If the user wants to also dispense coffee, then it is sufficient, following the operation of the machine with the function to froth the milk, to open the lever 13 of the machine so as to introduce a capsule containing coffee, 14, into the infusion assembly 8.

At this point, the machine is set up to start the function of dispensing the coffee as soon as the jets of hot water have stopped and the milk is frothed within the vessel 12.

In such case, in fact, the solenoid valve 9, as shown in FIG. 4, closes and the water from the heating unit 5 is conveyed to the infusion assembly 8, passes through the capsule 14, and thus the coffee is dispensed through the pipe 18 that is connected to the output opening 10.

In this manner, two different operating modes are available to the operator, which can be selected independently of each other, or in combination.

This means that the operator can decide to simply froth milk, thus operating the machine in the mode according to FIG. 3, or he or she can decide to dispense coffee only, thus operating the machine in the mode shown in FIG. 4, without hot water in jets has been dispensed into the vessel first, since the emulsion of the milk in this case has not been requested by the operator.

Finally, the operator can operate the machine as illustrated in the combination in FIGS. 3 and 4, with the dispensing of jets of hot water first, in order to emulsify the milk contained in the vessel 12, followed by the dispensing of coffee by way of the infusion assembly 8 in order to thus provide a cappuccino.

The water is dispensed with high pressure jets and thus a pump is necessary that has a low flow-rate but a high pressure.

The pump 20 can therefore operate both in pulsed mode and in continuous mode. The pulsed jet of water can be controlled in terms of volume or time, where it is possible to regulate both by electronic means.

In practice it has been found that the machine according to the invention fully achieves the set aim and objects, in that it makes it possible to dispense espresso coffee or another beverage, froth the milk, prepare a cappuccino by first frothing the milk and subsequently dispensing the espresso coffee, without parts of the machine coming into contact with the milk, with the advantage, i.e. the possibility of not carrying out any cleaning operation, precisely because the milk does not come into contact with parts of the machine.

Furthermore, the fact of being able to froth the milk with jets of hot water, without using steam, ensures that the machine consumes less energy than machines that traditionally use jets of steam for the emulsion of milk.

The machine, thus conceived, is susceptible of numerous modifications and variations, all of which are within the scope of the appended claims.

Moreover, all the details may be substituted by other, technically equivalent elements.

In practice the materials employed, and the contingent dimensions and shapes, may be any according to requirements and to the state of the art.

The disclosures in Italian Patent Application No. MI2013A001726 from which this application claims priority are incorporated herein by reference.

1-7. (canceled)

8. An automatic machine for preparing beverages, such as espresso coffee, cappuccino and the like, comprising a water reservoir, a pump, a heating unit, a flow meter interposed between the water reservoir and the pump, and an infusion assembly for accommodating capsules or pods for preparing beverages, and further comprising means for dispensing hot water in jets, for the emulsion of milk contained in a vessel that is adapted to be arranged below the dispensing opening of said machine.

9. The machine according to claim 8, wherein said means adapted to emit hot water in jets comprise a solenoid valve that is arranged downstream of said heating unit and is adapted to receive hot water from said heating unit, said solenoid valve being connected to an additional delivery outlet of said machine by way of a tube.

10. The machine according to claim 9, wherein said tube adapted to connect said solenoid valve to said additional delivery outlet of the machine comprises at least one portion made of silicone rubber.

11. The machine according to claim 9, wherein said infusion assembly is connected, downstream of said heating unit, in parallel to said solenoid valve and to said tube that connects said solenoid valve to the additional outlet for delivery of hot water in jets of said machine.

12. The machine according to claim 9, wherein when said solenoid valve is closed, the water from said heating unit is conveyed to said infusion assembly.

13. The machine according to claim 9, wherein said pump has both pulsed and continuous operation.

14. A method for preparing beverages, such as cappuccino and the like, by way of an apparatus according to claim 8, comprising the steps of:
if a user wishes to prepare a cappuccino or latte macchiato, filling the vessel with milk and placing it under the dispensing opening of said machine;
operating the button for preparing frothed milk;
said selection on the part of the user causes said solenoid valve to open, in order to allow the passage of hot water in jets from said heating unit to said vessel, for the emulsion of the milk;
after the beginning of the milk emulsion cycle, opening the infusion assembly in order to introduce a capsule or pod that contains a preparation for a beverage;
at the end of the milk emulsion step, said solenoid valve closes, said solenoid valve closure step being controlled by the choice of the operator to dispense a beverage in capsule form after the milk emulsion step;
conveying hot water from the heating unit to the infusion assembly, in order to dispense the beverage contained in the capsule, while the vessel already contains the emulsified milk;
dispensing the beverage into said vessel.
